(19) United States
(12) Patent Application Publication
(10) Pub. No.: US 2024/0028932 A1
(43) Pub. Date: Jan. 25, 2024

(54) TRANSLATION-BASED ALGORITHM FOR GENERATING GLOBAL AND EFFICIENT COUNTERFACTUAL EXPLANATIONS IN ARTIFICIAL INTELLIGENCE

(71) Applicant: JPMorgan Chase Bank, N.A., New York, NY (US)

(72) Inventors: Dan LEY, Crediton (GB); Saumitra MISHRA, London (GB); Daniele MAGAZZENI, London (GB)

(73) Assignee: JPMorgan Chase Bank, N.A., New York, NY (US)

(21) Appl. No.: 18/199,680

(22) Filed: May 19, 2023

Related U.S. Application Data
(60) Provisional application No. 63/391,966, filed on Jul. 25, 2022.

(51) Int. Cl. G06N 5/046; G06N 5/045

(52) U.S. Cl. CPC G06N 5/046; G06N 5/045

(57) ABSTRACT

Methods and systems for generating a counterfactual explanation with respect to a prediction are provided. The method includes: receiving a set of data items that relate to respective characteristics of a situation; generating a first prediction that corresponds to an undesirable outcome with respect to the situation based on the set of data items; generating a second prediction that corresponds to a desirable outcome with respect to the situation; and determining a counterfactual explanation that indicates a potential change to at least one data item included in the set of data items such that the potential change corresponds to the second prediction. The determination may be made by applying an artificial intelligence (AI) algorithm that uses a machine learning technique to analyze each respective data item included in the set of data items.

### CROSS-REFERENCE TO RELATED APPLICATIONS

This application claims the benefit of U.S. Provisional Patent Application Ser. No. 63/391,966, filed Jul. 25, 2022, which is hereby incorporated by reference in its entirety.

### BACKGROUND

### 1. Field of the Disclosure

This technology generally relates to methods and systems for generating a counterfactual explanation with respect to a prediction that corresponds to an undesirable outcome by applying an artificial intelligence algorithm to the prediction.

### 2. Background Information

Counterfactual explanations construct input perturbations that result in desired predictions from machine learning (ML) models. A key benefit of these explanations is their ability to offer recourse to affected individuals in certain settings, such as, for example, automated credit decisioning. Recent years have witnessed a surge of subsequent research, identifying desirable properties of counterfactual explanations, developing methods to model those properties, and understanding the weaknesses and vulnerabilities of the proposed methods. Importantly, however, the research efforts thus far have largely centered around local analysis, generating explanations for individual inputs.

Such analyses can vet model behavior at the instance-level, though it is seldom obvious that any of the resulting insights would generalize globally. For example, a local counterfactual explanation may suggest that a model is not biased against a protected attribute (e.g., race or gender), despite net biases existing. A potential way to gain such insights is to aggregate local explanations, but since the generation of counterfactual explanations is generally computationally expensive, it is not evident that such an approach would scale well or retain reliability. Nonetheless, whether during training or post-hoc evaluation, it is desirable that global understanding underpin the development of ML models prior to deployment thereof. Reliability and efficiency play important roles therein.

Accordingly, there is a need for a method for generating a counterfactual explanation with respect to a prediction that corresponds to an undesirable outcome by applying an artificial intelligence (AI) algorithm to the prediction.

### SUMMARY

The present disclosure, through one or more of its various aspects, embodiments, and/or specific features or sub-components, provides, inter alia, various systems, servers, devices, methods, media, programs, and platforms for methods and systems for generating a counterfactual explanation with respect to a prediction that corresponds to an undesirable outcome by applying an AI algorithm to the prediction.

According to an aspect of the present disclosure, a method for generating a counterfactual explanation with respect to a prediction is provided. The method is implemented by at least one processor. The method includes: receiving, by the at least one processor, a first set of data items that relate to respective characteristics of a first situation; generating, by the at least one processor, a first prediction that corresponds to an undesirable outcome with respect to the first situation based on the first set of data items; generating, by the at least one processor, a second prediction that corresponds to a desirable outcome with respect to the first situation; and determining, by the at least one processor, a first counterfactual explanation that indicates a potential change to at least one data item included in the first set of data items such that the potential change corresponds to the second prediction.

The determining may include applying an artificial intelligence (AI) algorithm that uses a machine learning technique to analyze each respective data item included in the first set of data items.

The method may further include: using the AI algorithm to assign each respective data item included in the first set of data items to at least one from among a first subset that includes at least one numeric feature and a second subset that includes at least one categorical feature; and converting each categorical feature included in the second subset into a respective vector item that includes a corresponding direction and a corresponding magnitude. When the potential change relates to a first categorical feature included in the second subset, the method may further include using the AI algorithm to express the potential change as a set of if/then rules with exactly one then condition.

The set of if/then rules may include at least one potential change to the corresponding magnitude of the first categorical feature.

The method may further include calculating a first metric that relates to a reliability of the first counterfactual explanation, where the reliability varies directly with an accuracy of the first counterfactual explanation, and the reliability varies inversely with a recourse cost associated with the first counterfactual explanation.

The method may further include calculating a second metric that relates to an efficiency of the first counterfactual explanation that relates to a computation time that is required for generating the first counterfactual explanation.

The method may further include analyzing the first counterfactual explanation to determine whether at least one from among a first bias that relates to a gender and a second bias that relates to race is indicated by the first counterfactual explanation.

When a determination is made that the at least one from among the first bias and the second bias is indicated by the first counterfactual explanation, the method may further include modifying an underlying model associated with the first counterfactual explanation so as to reduce an effect of the at least one from among the first bias and the second bias.

The first situation may relate to at least one from among a credit risk, a default risk with respect to a customer payment, and a recidivism risk with respect to criminal activity.

According to another exemplary embodiment, a computing apparatus for generating a counterfactual explanation with respect to a prediction is provided. The computing apparatus includes a processor; a memory; and a communication interface coupled to each of the processor and the memory. The processor is configured to:

receive, via the communication interface, a first set of data items that relate to respective characteristics of a first situation; generate a first prediction that corresponds to an undesirable outcome with respect to the first situation based on the first set of data items; generate a second prediction that corresponds to a desirable outcome with respect to the first situation; and determine a first counterfactual explanation that indicates a potential change to at least one data item included in the first set of data items such that the potential change corresponds to the second prediction.

The processor may be further configured to determine the first counterfactual explanation by applying an artificial intelligence (AI) algorithm that uses a machine learning technique to analyze each respective data item included in the first set of data items.

The processor may be further configured to: use the AI algorithm to assign each respective data item included in the first set of data items to at least one from among a first subset that includes at least one numeric feature and a second subset that includes at least one categorical feature; and convert each categorical feature included in the second subset into a respective vector item that includes a corresponding direction and a corresponding magnitude. When the potential change relates to a first categorical feature included in the second subset, the processor may be further configured to use the AI algorithm to express the potential change as a set of if/then rules with exactly one then condition.

The set of if/then rules may include at least one potential change to the corresponding magnitude of the first categorical feature.

The processor may be further configured to calculate a first metric that relates to a reliability of the first counterfactual explanation, where the reliability varies directly with an accuracy of the first counterfactual explanation, and the reliability varies inversely with a recourse cost associated with the first counterfactual explanation.

The processor may be further configured to calculate a second metric that relates to an efficiency of the first counterfactual explanation that relates to a computation time that is required for generating the first counterfactual explanation.

The processor may be further configured to analyze the first counterfactual explanation to determine whether at least one from among a first bias that relates to a gender and a second bias that relates to race is indicated by the first counterfactual explanation.

When a determination is made that the at least one from among the first bias and the second bias is indicated by the first counterfactual explanation, the processor may be further configured to modify an underlying model associated with the first counterfactual explanation so as to reduce an effect of the at least one from among the first bias and the second bias.

The first situation may relate to at least one from among a credit risk, a default risk with respect to a customer payment, and a recidivism risk with respect to criminal activity.

According to yet another exemplary embodiment, a non-transitory computer readable storage medium storing instructions for generating a counterfactual explanation with respect to a prediction is provided. The storage medium includes executable code which, when executed by a processor, causes the processor to: receive a first set of data items that relate to respective characteristics of a first situation; generate a first prediction that corresponds to an undesirable outcome with respect to the first situation based on the first set of data items; generate a second prediction that corresponds to a desirable outcome with respect to the first situation; and determine a first counterfactual explanation that indicates a potential change to at least one data item included in the first set of data items such that the potential change corresponds to the second prediction.

When executed by the processor, the executable code may further cause the processor to determine the first counterfactual explanation by applying an artificial intelligence (AI) algorithm that uses a machine learning technique to analyze each respective data item included in the first set of data items.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating a counterfactual explanation with respect to a prediction that corresponds to an undesirable outcome by applying an AI algorithm to the prediction.

FIG. 4 is a flowchart of an exemplary process for implementing a method for generating a counterfactual explanation with respect to a prediction that corresponds to an undesirable outcome by applying an AI algorithm to the prediction.

FIG. 5 is an algorithm that is usable for implementing a method for generating a counterfactual explanation with respect to a prediction that corresponds to an undesirable outcome by applying an AI algorithm to the prediction, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

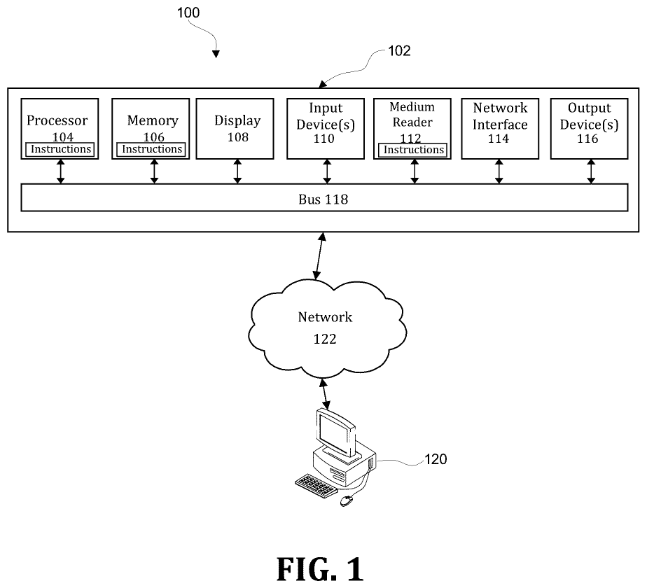

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating a counterfactual explanation with respect to a prediction that corresponds to an undesirable outcome by applying an AI algorithm to the prediction.

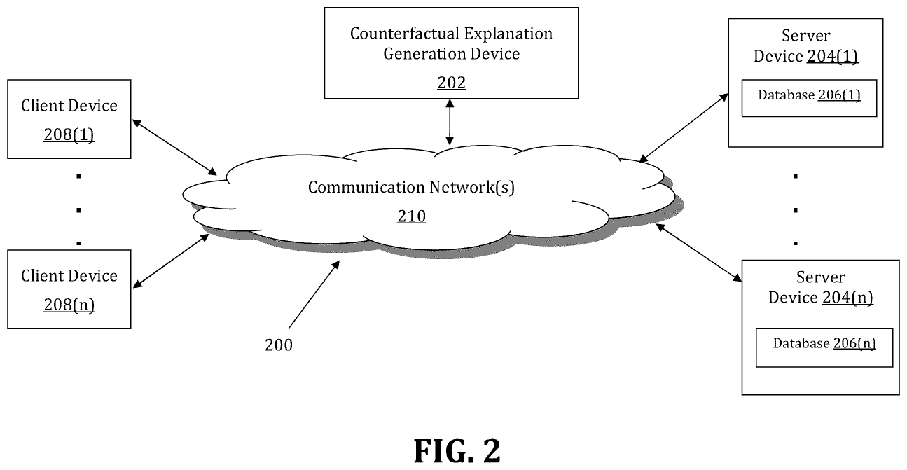

Referring to FIG. 2, a schematic of an exemplary network environment 200 for implementing a method for generating a counterfactual explanation with respect to a prediction that corresponds to an undesirable outcome by applying an AI algorithm to the prediction is illustrated. In an exemplary embodiment, the method is executable on any networked computer platform, such as, for example, a personal computer (PC).

The method for generating a counterfactual explanation with respect to a prediction that corresponds to an undesirable outcome by applying an AI algorithm to the prediction may be implemented by a Counterfactual Explanation Generation (CEG) device 202. The CEG device 202 may be the same or similar to the computer system 102 as described with respect to FIG. 1. The CEG device 202 may store one or more applications that can include executable instructions that, when executed by the CEG device 202, cause the CEG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CEG device 202 itself, may be located in virtual server(s) running in a cloud-based computing environment rather than being tied to one or more specific physical network computing devices. Also, the application(s) may be running in one or more virtual machines (VMs) executing on the CEG device 202. Additionally, in one or more embodiments of this technology, virtual machine(s) running on the CEG device 202 may be managed or supervised by a hypervisor.

In the network environment 200 of FIG. 2, the CEG device 202 is coupled to a plurality of server devices 204(1)-204(n) that hosts a plurality of databases 206(1)-206(n), and also to a plurality of client devices 208(1)-208(n) via communication network(s) 210. A communication interface of the CEG device 202, such as the network interface 114 of the computer system 102 of FIG. 1, operatively couples and communicates between the CEG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CEG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CEG devices that efficiently implement a method for generating a counterfactual explanation with respect to a prediction that corresponds to an undesirable outcome by applying an AI algorithm to the prediction.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CEG device 202 may be a standalone device or integrated with one or more other devices or apparatuses, such as one or more of the server devices 204(1)-204(n), for example. In one particular example, the CEG device 202 may include or be hosted by one of the server devices 204(1)-204(n), and other arrangements are also possible. Moreover, one or more of the devices of the CEG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CEG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to historical model outputs and information that relates to metrics for reliability and efficiency of counterfactual explanations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CEG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CEG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CEG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CEG device 202, the server devices 204(1)-204(n), or the client devices 208(1)-208(n), for example, may be configured to operate as virtual instances on the same physical machine. In other words, one or more of the CEG device 202, the server devices 204(1)-204(n), or the client devices 208(1)-208(n) may operate on the same physical device rather than as separate devices communicating through communication network(s) 210. Additionally, there may be more or fewer CEG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

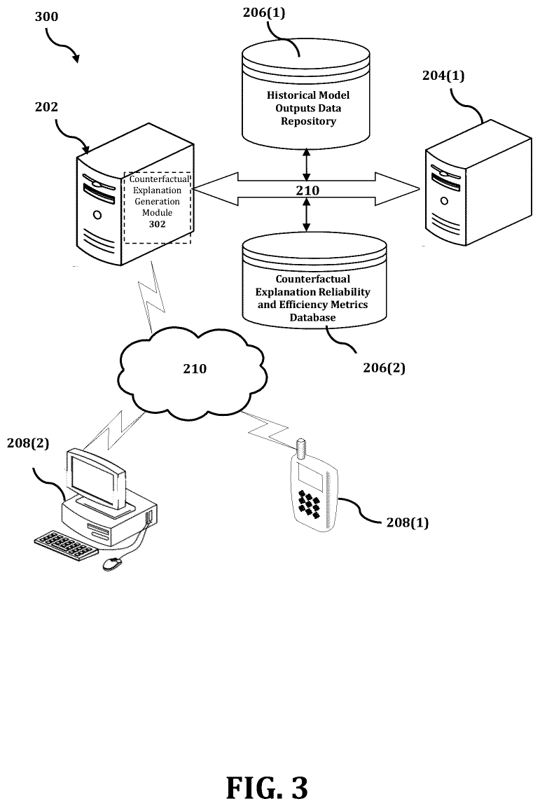

The CEG device 202 is described and illustrated in FIG. 3 as including a counterfactual explanation generation module 302, although it may include other rules, policies, modules, databases, or applications, for example. As will be described below, the counterfactual explanation generation module 302 is configured to implement a method for generating a counterfactual explanation with respect to a prediction that corresponds to an undesirable outcome by applying an AI algorithm to the prediction.

An exemplary process 300 for implementing a mechanism for generating a counterfactual explanation with respect to a prediction that corresponds to an undesirable outcome by applying an AI algorithm to the prediction by utilizing the network environment of FIG. 2 is illustrated as being executed in FIG. 3. Specifically, a first client device 208(1) and a second client device 208(2) are illustrated as being in communication with CEG device 202. In this regard, the first client device 208(1) and the second client device 208(2) may be “clients” of the CEG device 202 and are described herein as such. Nevertheless, it is to be known and understood that the first client device 208(1) and/or the second client device 208(2) need not necessarily be “clients” of the CEG device 202, or any entity described in association therewith herein. Any additional or alternative relationship may exist between either or both of the first client device 208(1) and the second client device 208(2) and the CEG device 202, or no relationship may exist.

Further, CEG device 202 is illustrated as being able to access a historical model outputs data repository 206(1) and a counterfactual explanation reliability and efficiency metrics database 206(2). The counterfactual explanation generation module 302 may be configured to access these databases for implementing a method for generating a counterfactual explanation with respect to a prediction that corresponds to an undesirable outcome by applying an AI algorithm to the prediction.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CEG device 202 via broadband or cellular communication. Of course, these embodiments are merely exemplary and are not limiting or exhaustive.

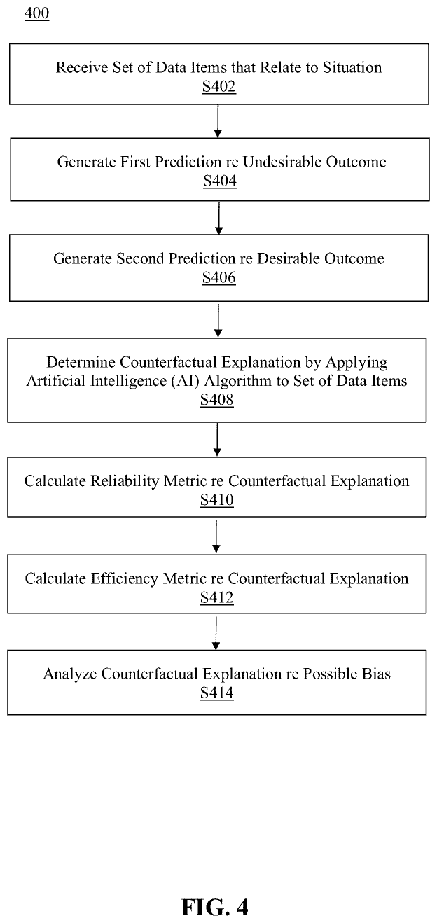

Upon being started, the counterfactual explanation generation module 302 executes a process for generating a counterfactual explanation with respect to a prediction that corresponds to an undesirable outcome by applying an AI algorithm to the prediction. An exemplary process for generating a counterfactual explanation with respect to a prediction that corresponds to an undesirable outcome by applying an AI algorithm to the prediction is generally indicated at flowchart 400 in FIG. 4.

In process 400 of FIG. 4, at step S402, the counterfactual explanation generation module 302 receives a first set of data items that relate to respective characteristics of a particular situation. In an exemplary embodiment, the particular situation may relate to a credit risk, a default risk with respect to a customer payment, a recidivism risk with respect to criminal activity, and/or any other type of situation for which a prediction may be made, with potential outcomes that are either favorable, unfavorable, desirable, and/or undesirable.

The data items may include a first subset of items that include numeric features and a second subset of items that include categorical features. Each categorical feature may be characterized as a vector that includes a corresponding magnitude and a corresponding direction. In some instances, a data item may include both numeric feature(s) and categorical feature(s) and may thus be included in both the first subset and the second subset.

At step S404, the counterfactual explanation generation module 302 generates a first prediction that corresponds to an undesirable or unfavorable outcome. For example, in a situation that relates to a default risk with respect to a customer payment, a prediction that the default risk is relatively high corresponds to an undesirable or unfavorable outcome; and in a situation that relates to a recidivism risk with respect to criminal activity, a prediction that the recidivism risk is relatively high corresponds to an undesirable or unfavorable outcome.

At step S406, the counterfactual explanation generation module 302 generates a second prediction that corresponds to a desirable or favorable outcome. For example, in the situation that relates to a default risk with respect to a customer payment, a prediction that a particular individual is unlikely to default on a payment corresponds to a desirable or favorable outcome; and in the situation that relates to a recidivism risk with respect to criminal activity, a prediction that the particular individual is unlikely to commit another crime corresponds to a desirable or favorable outcome.

At step S408, the counterfactual explanation generation module 302 determines a counterfactual explanation that indicates a potential change to at least one data item included in the set of data items received in step S402, such that the desirable or favorable prediction would be more likely as a result of the potential change. In an exemplary embodiment, the determination of the counterfactual explanation is made by applying an artificial intelligence (AI) algorithm to each data item included in the set of data items received in S402.

In an exemplary embodiment, when the potential change relates to a categorical feature that is included in the set of data items received in S402, the AI algorithm may be used to express the potential change as a set of if/then rules with exactly one then condition. The set of if/then rules may include at least one potential change to the magnitude of that same categorical feature.

At step S410, the counterfactual explanation generation module 302 calculates a first metric that relates to a reliability of the counterfactual explanation determined in step S408. In an exemplary embodiment, the reliability indicates a combination of accuracy and recourse cost associated with the counterfactual explanation, such that a higher accuracy corresponds to a higher reliability, and a lower recourse cost also corresponds to a higher reliability.

At step S412, the counterfactual explanation generation module 302 calculates a second metric that relates to an efficiency of the counterfactual explanation determined in step S408. In an exemplary embodiment, the efficiency is correlated with a computation time that is required for generating the counterfactual explanation.

At step S414, the counterfactual explanation generation module 302 analyzes the counterfactual explanation to determine whether there is a bias, such as a gender bias or a racial bias, that is indicated by the counterfactual explanation. In an exemplary embodiment, when a determination is made that such a bias is indicated by the counterfactual explanation, the counterfactual explanation generation module 302 may modify an underlying model associated with the counterfactual explanation in order to reduce the effect of the bias.

Counterfactual explanations have been widely studied in explainability, with a range of application dependent methods emerging in fairness, recourse and model understanding. However, the major shortcoming associated with conventional methods is their inability to provide explanations beyond the local or instance-level. While many works touch upon the notion of a global explanation, typically suggesting to aggregate masses of local explanations in the hope of ascertaining global properties, a framework that is both reliable and computationally tractable has proven elusive. Meanwhile, practitioners are requesting more efficient and interactive explainability tools. In an exemplary embodiment, the present inventive concept relates to Global & Efficient Counterfactual Explanations (GLOBE-CE), a novel and flexible black box framework that tackles the scalability issues associated with the current state-of-the-art, particularly on higher dimensional datasets and in the presence of continuous features. Furthermore, a unique mathematical analysis of categorical feature translations is described and utilized in this methodology.

Reliability and efficiency play important roles in the context of global counterfactual explanations (GCEs). In an exemplary embodiment, GCEs are applicable to multiple inputs simultaneously, while maximizing accuracy across such inputs. For clarity, the term “counterfactuals” refers herein to altered inputs, and the term “counterfactual explanations” refers herein to the extension of counterfactuals to any of their possible representations e.g., translation vectors, rules that denote fixed values, etc.

The present disclosure includes a discussion of the current state of GCEs, specifically reporting on the recently proposed Actionable Recourse Summaries (AReS) framework. In an exemplary embodiment, AReS is revealed as being both computationally expensive and relatively sensitive to continuous features. Then, an outline of a Fast AReS implementation is described, whereby proposed amendments to the algorithm are demonstrated as leading to significant speed and performance improvements on four benchmarked financial datasets.

In an exemplary embodiment, a framework for the GLOBE-CE has the ability to seek answers to the big picture questions regarding a model's recourses, namely the potential disparities between affected subgroups, i.e., Do race or gender biases exist in the recourses of a model? Can these be reliably conveyed these in an interpretable manner?

Each GCE is represented with a single translation vector 6, multiplied by an input-dependent, scalar variable k. To determine the direction of each translation, the framework deploys a general CE generation scheme, flexible to various desiderata. These include but are not limited to sparsity, diversity, actionability and model-specific CEs. Importantly, in an exemplary embodiment, the inventive concept encompasses the notions of a) varying k input-wise and b) proving that arbitrary translations on one-hot encodings can be expressed using If/Then rules.

In an exemplary embodiment, the GLOBE-CE framework has a high efficacy, as measured along three fundamental dimensions: accuracy (i.e., the percentage of inputs with successfully altered predictions), average cost (i.e., the difficulty associated with executing successful GCEs) and speed (i.e., the time spent computing GCEs). Further, it is suggested that GCEs that fail to attain maximum accuracy or minimum cost can be misleading, raising concerns around the safety of ML models vetted by such explanations. Thus, by targeting these metrics, the present inventive concept provides significant speedups at concurrently higher accuracies and lower costs. In addition, the GLOBE-CE framework has the ability to reliably detect recourse biases where previous methods fall short.

Local Counterfactual Explanations: In the context of understanding black box ML models, a local counterfactual explanation may be understood as referring to points that are relatively close to the query input, with respect to some distance metric, that result in a desired prediction. This notion has led to various approaches to generate local counterfactual explanations, including some that emphasize the importance of diversity and others that aim to generate plausible CEs by considering proximity to the data manifold or by accounting for causal relations among input features. Actionability of recourse is another important desideratum, suggesting certain features be excluded or limited. In another direction, some approaches generate CEs for specific model categories, such as tree-based or differentiable models.

Despite a growing desire from practitioners for global explanation methods that provide summaries of model behavior, the struggles associated with summarizing complex, high-dimensional models globally have yet to be comprehensively resolved. Some manner of local explanation aggregation has been suggested, though no compelling results have been shown that are both reliable and computationally tractable for GCEs.

Actionable Recourse Summaries (AReS): AReS represents a comprehensive, model-agnostic GCE framework. AReS adopts an interpretable structure, termed two level recourse sets, which include triples of the form Outer-If/Inner-If/Then conditions. Subgroup descriptors SD (i.e., Outer-If conditions) and recourse rules RL (i.e., frequent item sets output by apriori) determine such triples. Iteration over SD×RL² yields the ground set V, before a submodular maximization algorithm computes the final set R⊆V using an objective f(R). One strength of AReS is thus in assessing fairness via the disparate impact of recourses, through user-defined SD.

However, AReS can fall short in two aspects. First re computational efficiency, it appears that AReS is highly dependent on the cardinality of the ground set V, resulting in an impractically large V to be optimized. Second, re continuous features, it has been found that binning continuous data prior to GCE generation, as in AReS, struggles to trade speed with performance. In particular, too few bins results in unrealistic recourses, while too many bins results in excessive computation.

In an exemplary embodiment, the proposed Global & Efficient Counterfactual Explanations (GLOBE-CE) framework is described below, including the following: 1) the gap in research between reliability and efficiency, 2) the representation of GCEs that are chosen, assisted by theoretical results on categorical feature arithmetic, 3) the GLOBE-CE algorithm, and 4) the adaptability of this framework to existing CE desiderata.

Motivation: Global Counterfactual Explanations are reliable or efficient, but not both. Reliability is defined herein as referring to reliable GCEs which are those that maximize accuracy while minimizing recourse costs. Both metrics critically impact bias assessment. In the absence of minimum cost recourses, biases may be detected where not present (A₁, B₁) or not detected where present (A₂, B₂). Similarly, without sufficient accuracy, the same phenomena may occur (A₃, B₃ and A₄, B₄, respectively). The further these metrics stray from optimal, the less likely any potential subgroup comparisons are of being reliable.

Efficiency: There exists a gap in GCE research between reliability and efficiency. Even the most comprehensive works that target maximum reliability suffer computation times in excess of three hours on relatively small datasets. In parallel, there exists a body of research advocating strongly the use of inherently interpretable models for these cases, where performance is not compromised. The utility in black box explanations is thus mainly reserved for more complex scenarios, and therefore, in an exemplary embodiment, a global method that both executes efficiently and scales well is sought.

In an exemplary embodiment, a novel and interpretable GCE representation provides scaled translation vectors. In this aspect, for every input that belongs to a particular subgroup xϵX_{sub}, a translation δ with scalar k may be applied such that x_{CF}=round(x+kδ) is a successful counterfactual. Note that round(x) re-encodes categorical outputs by selecting the largest feature values post-translation. For each xϵX_{sub}, this framework computes the respective minimum value of k required for recourse. Unlike prior work, this implies that a wide range of minimum costs and potentially complex, non-linear decision boundaries may be tackled, despite a fixed direction S.

Categorical Feature Arithmetic: One-hot encodings are assumed for categorical features (else, these can be trivially encoded and decoded to suit), and a report is provided that mathematically characterizes the interpretation of a translation kδ on a one-hot encoding, including the effects of scaling, yielding deterministic, interpretable rules from kδ.

Theorem 1. Regardless of feature value, any translation vector that is added to a one-hot categorical feature can alternatively be expressed as a set of If/Then rules with just one unique Then condition. Proof (sketch): Consider any one-hot encoded feature vector with feature labels ranging from 1 to n, denoted f=[f₁,f₂, . . . , fₙ] ϵ{0,1}ⁿ, where |f|₁=1 and F=argmaxᵢfᵢ. Similarly, consider a translation vector of size n, denoted δ=[δ₁,δ₂, . . . , δₙ]ϵRⁿ, where Δ=argmaxᵢδᵢ. The final vector post-translation is g=f+δ, and the final feature value is G=argmaxᵢgᵢ. Note g_{i=F}=δᵢ and g_{F}=δ_{F}+1. Denote g_{G}=maxᵢgᵢ=max(δ_{F}+1,max_{i≠F}(δᵢ)). For 1≤F≤n, it is now proven that if G≠F (i.e. a change in feature value occurs), then the rule “If F, Then Δ” holds. In the case F=Δ, g_{G}=max(δ_{Δ}+1,maxᵢ(δ_{i=Δ}))=δ_{Δ}+1, as δ_{Δ}=maxᵢδᵢ. Hence, G=Δ (no rule). In the case F≠Δ, g_{G}=max(δ_{F}+1,δ_{Δ}). If δ_{F}+1>δ_{Δ}, then g_{G}=δ_{F}+1 and G=F (no rule). However, if δ_{F}+1<δ_{Δ}, then g_{G}=δ_{Δ}and G=Δ, giving the rule “If F, Then Δ”.

Theorem 2. Regardless of feature value, any translation vector that is scaled by k≥0 and added to a one-hot categorical feature can alternatively be expressed with the first m rules of a fixed sequence. Proof (sketch): Consider the general vectors f and δ defined in Theorem 1, and scalar k. For i≠Δ and k>0, Theorem 1 gives that kδᵢ+1<kδ_{Δ}yields the rule “If i, Then Δ”. Rearranging gives that if the lower bound

$$k > \frac{1}{{δ}_{Δ} - {δ}_{i}}$$

is satisfied, then the translation kδ induces such a rule. Consider additionally the vector of lower bounds k=[k₁,k₂, . . . , kₙ] ϵ [symbol]
₊ⁿ where

$${k}_{i \neq Δ} = \frac{1}{{δ}_{Δ} - {δ}_{i}}$$

and k_{Δ}=∞.

Lemma 2.1. By inspection, it is apparent that kᵢ≤kₘ for any i,m<n pair with δᵢ≤δₘ. As such, lower bounds for i and m are both satisfied if k>kₘ. Thus, scaling δ by k>kₘ induces not only the rule corresponding to feature value m, but also that of any other feature value i with δᵢ≤δₘ.

For k=0, there are no rules (trivially, kδ=0). Let Δᵢ now be the index of the i^{th} smallest value in δ, such that Δ₁=argminᵢδᵢ and Δₙ=argmaxᵢδᵢ=Δ. Thus, by Lemma 2.1, for m<n, it may be seen that scaling δ by k_{Δm}<k≤k_{Δm+1} induces rules for each of the first m feature values Δ_{1≤i≤m}.

The GLOBE-CE Algorithm: Learning and Interpreting Translations: Any particular local CE may be represented with a fixed magnitude translation. In an exemplary embodiment, a major contribution of the GLOBE-CE framework lies in the notion of scaling the magnitudes of translations. Though perhaps an uninteresting concept in the context of local CEs, the claim is that, with large numbers of inputs present, scaling a translation δ with a variable k is an elegant and efficient way of solving for global summaries of a model's decision boundary.

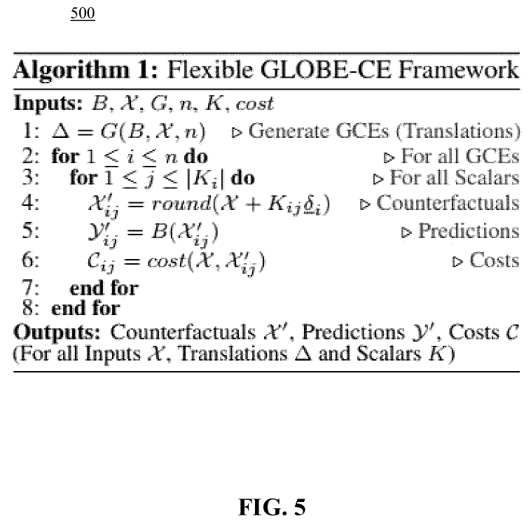

FIG. 5 is an algorithm 500 that is usable for implementing a method for generating a counterfactual explanation with respect to a prediction that corresponds to an undesirable outcome by applying an AI algorithm to the prediction, according to an exemplary embodiment. In this setup, explanations are learned by adopting methods from instance level CE research, generalizing for any CE algorithm G(B,X,n) that considers, at a minimum, the model B being explained, the inputs requiring explanations X, and the number n of returned GCEs δ₁,ϵ₂, . . . , δₙ=Δ. The i^{th} GCE δᵢ is scaled over a range of m scalars Kₙ,Kᵢ₂, . . . , Kᵢₘ, repeating over all 1≤i≤n GCEs and returning the counterfactuals

Y′ϵ{0,1}n×m×|X| and costs [symbol]
ϵ [symbol]
_{≥0}^{n×m×|X|}.

In an exemplary embodiment, it is posited that the method of a) assigning a single vector direction to an entire subgroup of inputs, b) traveling along this vector, and c) analyzing the minimum costs required for successful recourses per input of the subgroup, is the natural global extension to one of the simplest forms of local CE: the fixed magnitude translation. In fact, the connection between local and global explanations may be more intimate than current research implies. Works suggesting to learn global summaries from local explanations and approaches suggesting to learn global summaries directly tend to approach global explanations from the angle that they are fundamentally different problems. The framing of GCEs as a local problem is akin to treating groups of inputs as single instances, generating translations for them and subsequently, through scaling, efficiently capturing the true range of properties across the set of local instances and their proximity to the decision boundary.

Interpreting Translations: The manner in which explanations are portrayed depends on the nature of the data and/or the desire to compare recourses. In an exemplary embodiment, straightforward interpretations of GCEs are introduced in continuous and categorical contexts, together with the corresponding accuracy/cost properties.

In an exemplary embodiment, a scaling approach induces accuracy-cost profiles, thus providing an interpretable method for the selection of a particular accuracy/cost combination, as well as for bias assessment. Intuitively, if the magnitude of a translation is zero (when k=0), its accuracy and cost are also zero; and, as the magnitude grows, more inputs successfully cross the decision boundary, resulting in an increase in accuracy and average cost. Accuracy/cost values can then be chosen or compared.

In an exemplary embodiment, standard statistical methods are adopted to convey minimum costs, which correspond to the minimum scalars required to alter each input's prediction. For continuous data, where costs scale linearly as a particular translation is scaled, it is deemed interpretable to display solely mean translations alongside the illustration of minimum costs.

Prior to this analysis, translations as raw vectors in input space lacked an immediate and intuitive interpretation on categorical data. Theorem 1 demonstrates that any translation can be interpreted as a series of “If/Then” rules, limited to one “Then” condition per feature. Theorem 2 consequently proves that as a translation is scaled, “If” conditions are added to the rules for each feature. In an exemplary embodiment, the resultant GCE representation is referred to as a Cumulative Rules Chart (CRC).

Adapting the Generation Algorithm for CE Desiderata & Bias Analysis: Recognizing the scope of possible GCE generation algorithms to be vast, it should be stated that modifications to G along arbitrary criteria may impact efficiency in a variety of ways.

GCE Generation: In an exemplary embodiment, in the context of recourse, G(B,X,n) should deliver diverse and relatively sparse translations, targeting reliability (i.e., maximum accuracy, minimum cost) and taking into account that increasing diversity will likely reduce interpretability. Regarding actionability, associated feature-wise costs are assigned. In an exemplary embodiment, the generation algorithm G(B,X,n,nₛ,c,n_{f},p) comprises uniform random sampling of ns translations at a fixed cost c. The additional parameters control the number of features n_{f} (randomly chosen) in the translations, and the power p to which random samples between 0 and 1 are raised, respectively, offering control over sparsity. The n final GCEs are chosen to greedily maximize accuracy. There also exist model categories that provide alternative methods, such as, for example, model gradients in Deep Neural Networks (DNNs), feature attributions in XGBoost models (XGB), and the mathematics of Support Vector Machines (SVMs).

Bias Analysis: In an exemplary embodiment, the framework is extended to provide comparisons between affected subgroups of interest. Such an extension is a trivial matter of separating the inputs and evaluating and scaling GCEs separately. However, it is recommended to generate the same random ns translations for both subgroups as this a) eliminates any possible random bias in the translation generation and b) executes faster. Alternatively, the GCEs selected for each subgroup can be directly exchanged, such that direct comparison of recourse can be assessed.

Accordingly, with this technology, an optimized process for generating a counterfactual explanation with respect to a prediction that corresponds to an undesirable outcome by applying an AI algorithm to the prediction is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a counterfactual explanation with respect to a prediction, the method being implemented by at least one processor, the method comprising:
receiving, by the at least one processor, a first set of data items that relate to respective characteristics of a first situation;
generating, by the at least one processor, a first prediction that corresponds to an undesirable outcome with respect to the first situation based on the first set of data items;
generating, by the at least one processor, a second prediction that corresponds to a desirable outcome with respect to the first situation; and
determining, by the at least one processor, a first counterfactual explanation that indicates a potential change to at least one data item included in the first set of data items such that the potential change corresponds to the second prediction.

2. The method of claim 1, wherein the determining comprises applying an artificial intelligence (AI) algorithm that uses a machine learning technique to analyze each respective data item included in the first set of data items.

3. The method of claim 2, further comprising:
using the AI algorithm to assign each respective data item included in the first set of data items to at least one from among a first subset that includes at least one numeric feature and a second subset that includes at least one categorical feature; and
converting each categorical feature included in the second subset into a respective vector item that includes a corresponding direction and a corresponding magnitude,
wherein when the potential change relates to a first categorical feature included in the second subset, the method further comprises using the AI algorithm to express the potential change as a set of if/then rules with exactly one then condition.

4. The method of claim 3, wherein the set of if/then rules includes at least one potential change to the corresponding magnitude of the first categorical feature.

5. The method of claim 1, further comprising calculating a first metric that relates to a reliability of the first counterfactual explanation,
wherein the reliability varies directly with an accuracy of the first counterfactual explanation, and the reliability varies inversely with a recourse cost associated with the first counterfactual explanation.

6. The method of claim 5, further comprising calculating a second metric that relates to an efficiency of the first counterfactual explanation that relates to a computation time that is required for generating the first counterfactual explanation.

7. The method of claim 1, further comprising analyzing the first counterfactual explanation to determine whether at least one from among a first bias that relates to a gender and a second bias that relates to race is indicated by the first counterfactual explanation.

8. The method of claim 7, wherein when a determination is made that the at least one from among the first bias and the second bias is indicated by the first counterfactual explanation, the method further comprises modifying an underlying model associated with the first counterfactual explanation so as to reduce an effect of the at least one from among the first bias and the second bias.

9. The method of claim 1, wherein the first situation relates to at least one from among a credit risk, a default risk with respect to a customer payment, and a recidivism risk with respect to criminal activity.

10. A computing apparatus for generating a counterfactual explanation with respect to a prediction, the computing apparatus comprising:
a processor;
a memory; and
a communication interface coupled to each of the processor and the memory,
wherein the processor is configured to:
receive, via the communication interface, a first set of data items that relate to respective characteristics of a first situation;
generate a first prediction that corresponds to an undesirable outcome with respect to the first situation based on the first set of data items;
generate a second prediction that corresponds to a desirable outcome with respect to the first situation; and
determine a first counterfactual explanation that indicates a potential change to at least one data item included in the first set of data items such that the potential change corresponds to the second prediction.

11. The computing apparatus of claim 10, wherein the processor is further configured to determine the first counterfactual explanation by applying an artificial intelligence (AI) algorithm that uses a machine learning technique to analyze each respective data item included in the first set of data items.

12. The computing apparatus of claim 11, wherein the processor is further configured to:
use the AI algorithm to assign each respective data item included in the first set of data items to at least one from among a first subset that includes at least one numeric feature and a second subset that includes at least one categorical feature; and
convert each categorical feature included in the second subset into a respective vector item that includes a corresponding direction and a corresponding magnitude,
wherein when the potential change relates to a first categorical feature included in the second subset, the processor is further configured to use the AI algorithm to express the potential change as a set of if/then rules with exactly one then condition.

13. The computing apparatus of claim 12, wherein the set of if/then rules includes at least one potential change to the corresponding magnitude of the first categorical feature.

14. The computing apparatus of claim 10, wherein the processor is further configured to calculate a first metric that relates to a reliability of the first counterfactual explanation,
wherein the reliability varies directly with an accuracy of the first counterfactual explanation, and the reliability varies inversely with a recourse cost associated with the first counterfactual explanation.

15. The computing apparatus of claim 14, wherein the processor is further configured to calculate a second metric that relates to an efficiency of the first counterfactual explanation that relates to a computation time that is required for generating the first counterfactual explanation.

16. The computing apparatus of claim 10, wherein the processor is further configured to analyze the first counterfactual explanation to determine whether at least one from among a first bias that relates to a gender and a second bias that relates to race is indicated by the first counterfactual explanation.

17. The computing apparatus of claim 16, wherein when a determination is made that the at least one from among the first bias and the second bias is indicated by the first counterfactual explanation, the processor is further configured to modify an underlying model associated with the first counterfactual explanation so as to reduce an effect of the at least one from among the first bias and the second bias.

18. The computing apparatus of claim 10, wherein the first situation relates to at least one from among a credit risk, a default risk with respect to a customer payment, and a recidivism risk with respect to criminal activity.

19. A non-transitory computer readable storage medium storing instructions for generating a counterfactual explanation with respect to a prediction, the storage medium comprising executable code which, when executed by a processor, causes the processor to:
receive a first set of data items that relate to respective characteristics of a first situation;
generate a first prediction that corresponds to an undesirable outcome with respect to the first situation based on the first set of data items;
generate a second prediction that corresponds to a desirable outcome with respect to the first situation; and
determine a first counterfactual explanation that indicates a potential change to at least one data item included in the first set of data items such that the potential change corresponds to the second prediction.

20. The storage medium of claim 19, wherein when executed by the processor, the executable code further causes the processor to determine the first counterfactual explanation by applying an artificial intelligence (AI) algorithm that uses a machine learning technique to analyze each respective data item included in the first set of data items.
